(19) United States
(12) Patent Application Publication
(10) Pub. No.: US 2017/0162316 A1
(43) Pub. Date: Jun. 8, 2017

(54) COIL COMPONENT AND POWER SUPPLY CIRCUIT UNIT

(71) Applicant: TDK CORPORATION, Tokyo (JP)

(72) Inventors: Makoto ENDO, Tokyo (JP); Masamichi TANIGUCHI, Tokyo (JP); Katsunori OSANAI, Tokyo (JP)

(73) Assignee: TDK CORPORATION, Tokyo (JP)

(21) Appl. No.: 15/363,608

(22) Filed: Nov. 29, 2016

(30) Foreign Application Priority Data
Dec. 2, 2015 (JP) 2015-235752

(51) Int. Cl. H01F 27/28; H01F 27/245; H01F 27/29; H01F 27/32

(52) U.S. Cl. CPC H01F 27/2804; H01F 27/323; H01F 27/245; H01F 27/29; H01F 2027/2809

(57) ABSTRACT

In a coil component, an inorganic layer which is provided on a lower surface side of a coil has a thermal conductivity higher than that of a resin layer with which an upper surface of the coil is covered and gaps between windings are filled. As a result, heat transfer from the inside of the coil to the outside is supplemented via the inorganic layer. That is, heat transfer of the coil via the inorganic layer is facilitated, and heat dissipation of the coil component improves.

### CROSS-REFERENCE TO RELATED APPLICATIONS

This application is based upon and claims the benefit of priority from Japanese Patent Application No. 2015-235752, filed on Dec. 2, 2015, the entire contents of which are incorporated herein by reference.

### BACKGROUND OF THE INVENTION

Field of the Invention

This disclosure relates to a coil component and a power supply circuit unit.

Related Background Art

For example, Patent Literature 1 (Japanese Unexamined Patent Publication No. 2013-98257) discloses a coil component including a planar coil which is a coil component in the related art. The periphery of the planar coil disclosed in Patent Literature 1 is completely covered with insulative resin (polyimide resin or epoxy resin).

For example, the aforementioned coil component can be used in a power supply circuit unit. Overheating of particularly a power supply circuit unit through which a large current flows may cause functional degradation or damage to the power supply circuit unit. Each component of the unit requires high heat dissipation so as to prevent such overheating.

According to this disclosure, there is provided a coil component with improved heat dissipation, and a power supply circuit unit.

According to an aspect of this disclosure, there is provided a coil component comprising: a planar coil; an inorganic layer provided on a side of one surface of the planar coil and in direct contact with the planar coil; and a resin layer covering the other surface of the planar coil, the resin layer filling gaps between windings of the planar coil.

In the coil component, the inorganic layer is provided on the side of one surface of the planar coil. Since the inorganic layer has a thermal conductivity higher than that of the resin layer covering the other surface of the planar coil and filling the gaps between the windings, heat transfer from a high temperature side of the planar coil to a low temperature side is supported via the inorganic layer. That is, heat transfer of the planar coil via the inorganic layer is facilitated, and heat dissipation of the coil component improves.

The shape of the inorganic layer may be the same as that of a forming region of the planar coil. Alternatively, the shape of the inorganic layer may be the same as that of a region including a forming region of the planar coil and an inside region of the planar coil. The “the same shape” in this disclosure tolerates shape errors as tolerated in typical thin film forming technology or typical thin film processing technology.

According to another aspect of this disclosure, the coil component further includes an element body having a magnetic resin layer covering the planar coil, the inorganic layer, and the resin layer, and the element body having a mounting surface; a pair of terminal electrodes provided on the mounting surface of the element body; and a pair of extracting conductors extending from end portions of the planar coil to the pair of terminal electrodes.

The coil component may further include at least one of capacitor structures inside or outside of the coil component.

According to a still another aspect of this disclosure, there is provided a power supply circuit unit including the aforementioned coil component. As a result, the power supply circuit unit including a coil component having high heat dissipation is obtained. The power supply circuit unit may further include at least one capacitor.

### BRIEF DESCRIPTION OF THE DRAWINGS

FIG. 1 is a perspective view of a power supply circuit unit of an embodiment of this disclosure.

FIG. 2 is a circuit diagram illustrating an equivalent circuit of the power supply circuit unit illustrated in FIG. 1.

FIG. 3 is a perspective view of a coil component of an embodiment of this disclosure.

FIG. 4 is a sectional view of the coil component taken along line IV-IV in FIG. 3.

FIG. 5 is an exploded perspective view of the coil component illustrated in FIG. 3.

FIGS. 6A to 6D are views illustrating steps of making the coil component illustrated in FIG. 3.

FIGS. 7A to 7D are views illustrating steps of making the coil component illustrated in FIG. 3.

FIGS. 8A to 8D are views illustrating steps of making the coil component illustrated in FIG. 3.

FIG. 9 is a table illustrating thermal conductivities of various materials.

FIG. 10 is a view illustrating the pattern of heat transfer in the coil component illustrated in FIG. 3.

FIGS. 11A to 11C are views illustrating the shapes of inorganic layers in examples.

FIG. 12 is a graph illustrating a relationship between the maximum temperatures and the shapes of the inorganic layers in the examples.

FIG. 13 is a view illustrating a coil component having a structure different from that of the coil component illustrated in FIG. 3.

FIGS. 14A to 14C are views illustrating coil components having different structures.

FIGS. 15A to 15C are views illustrating power supply circuit units having different structures.

### DESCRIPTION OF THE PREFERRED EMBODIMENTS

Hereinafter, embodiments of this disclosure will be described in detail with reference to the accompanying drawings. In the description, the same reference signs are assigned to the same elements or elements having the same functions, and duplicated description will be omitted.

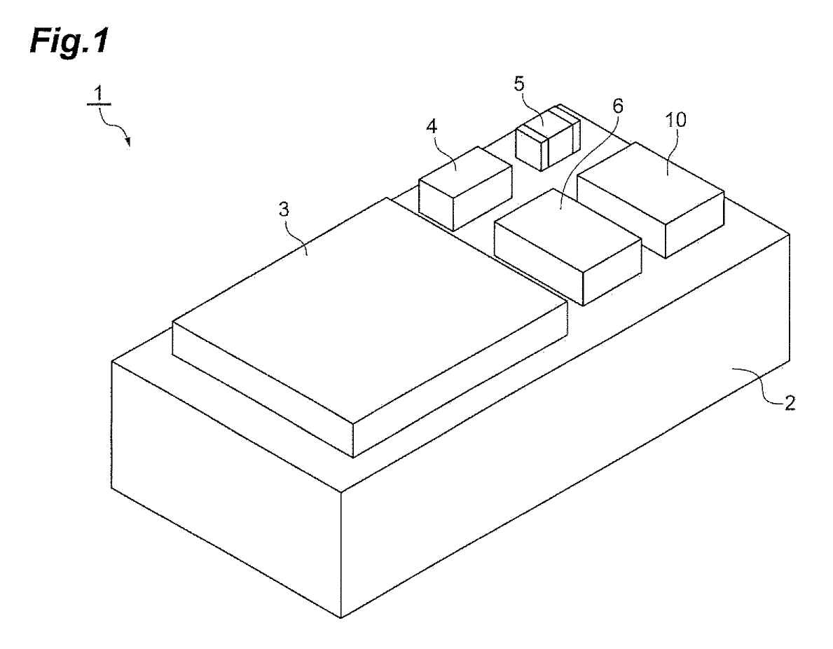

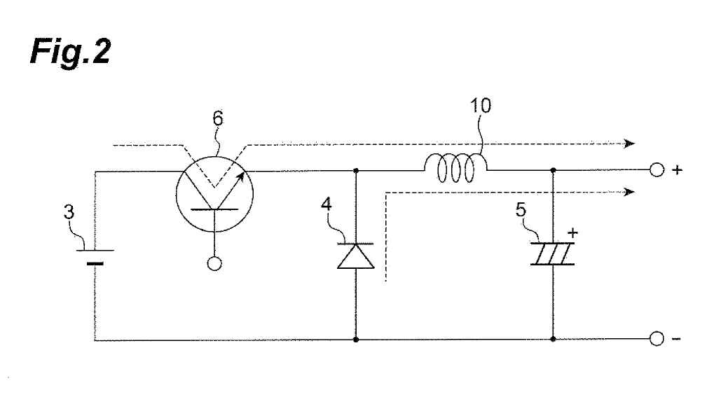

First, the entire configuration of a power supply circuit unit 1 of an embodiment of this disclosure will be described with reference to FIGS. 1 and 2. The power supply circuit unit to be described in the embodiment is a switching power supply circuit unit that converts (steps down) a direct voltage. As illustrated in FIGS. 1 and 2, the power supply circuit unit 1 includes a circuit substrate 2 and electronic components 3, 4, 5, 6 and 10. Specifically, a power supply IC 3, a diode 4, a capacitor 5, a switching element 6, and a coil component 10 are mounted on the circuit substrate 2.

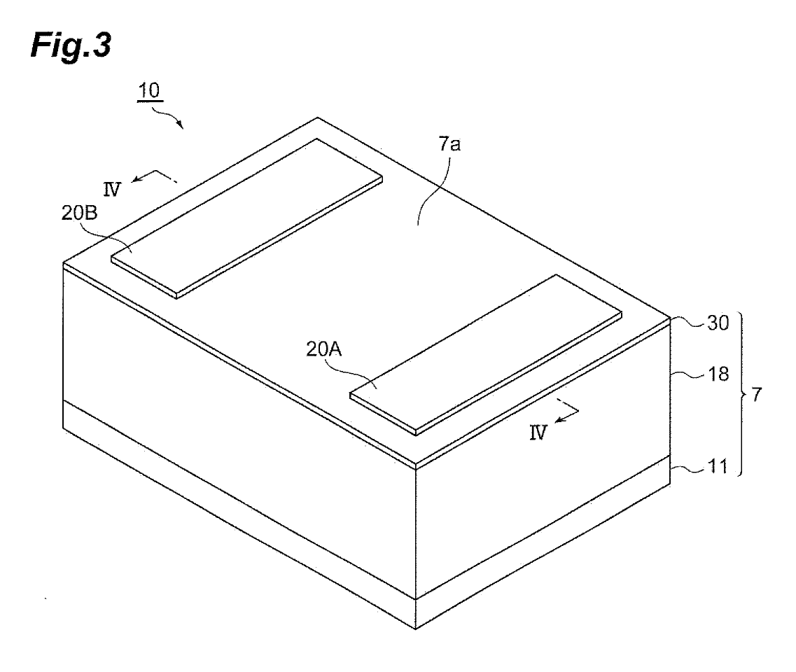

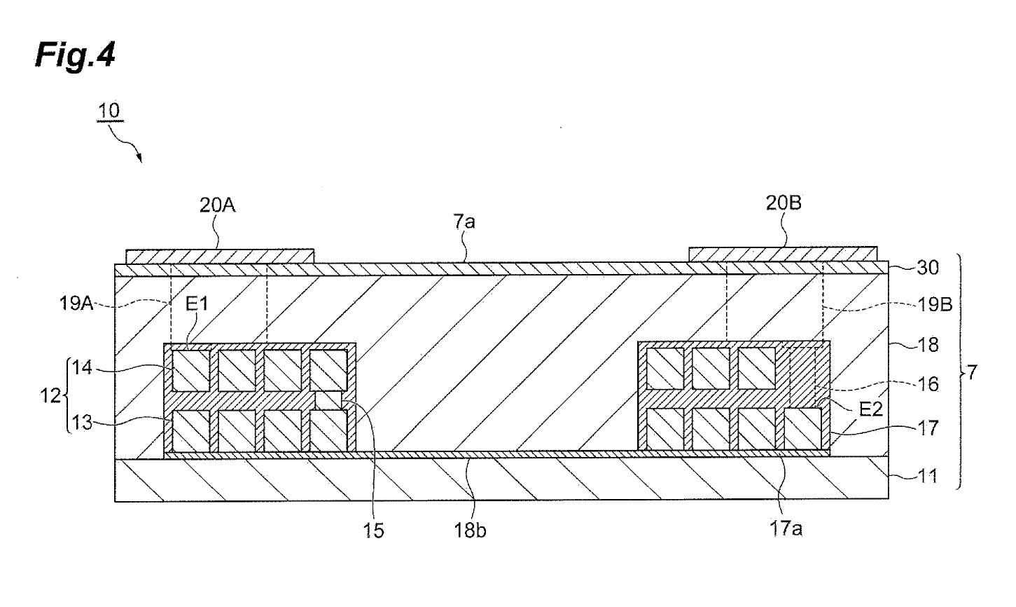

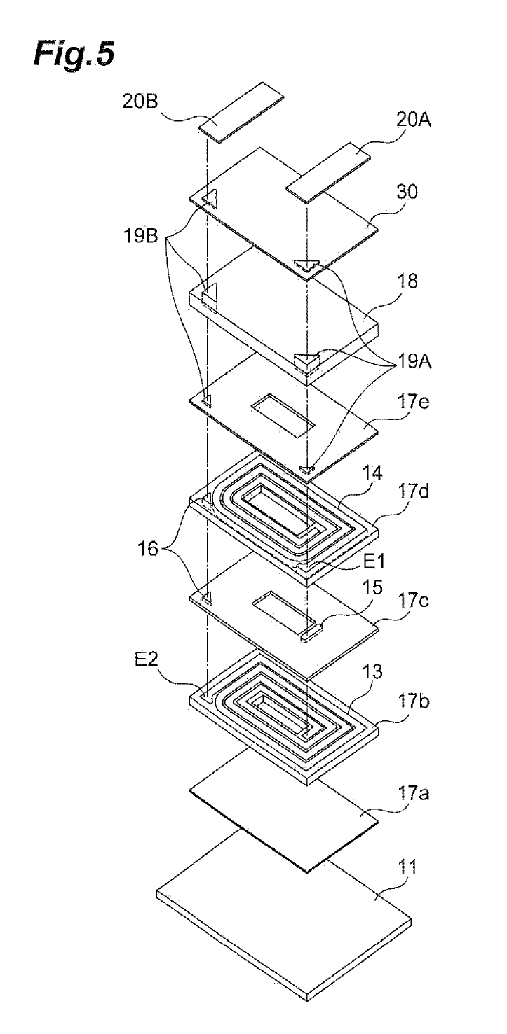

The configuration of the coil component 10 will be described with reference to FIGS. 3 to 5. FIG. 3 is a perspective view of the coil component 10. FIG. 4 is a sectional view of the coil component 10 taken along line IV-IV in FIG. 3. FIG. 5 is an exploded perspective view of the coil component. The exploded perspective view of FIG. 5 does not illustrate a magnetic resin layer 18 with which an inside portion of a coil 12 is filled.

As illustrated in FIG. 3, the coil component 10 includes an element body (magnetic element body) 7 inside of which the coil 12 (to be described later) is provided. The element body 7 has a rectangular parallelepiped exterior. Examples of the rectangular parallelepiped shape include a rectangular parallelepiped shape having chamfered corners and ridge portions, and a rectangular parallelepiped shape having rounded corners and ridge portions. The element body 7 includes a main surface 7a. The main surface 7a has a rectangular shape having long sides and short sides. Examples of the rectangular shape include a rectangular shape having rounded corners.

Terminal electrodes 20A and 20B are provided on the main surface 7a of the element body 7. The terminal electrode 20A is disposed along one short side of the main surface 7a, and the terminal electrode 20B is disposed along the other short side of the main surface 7a. The terminal electrodes 20A and 20B are spaced away from each other in a direction along the long sides of the main surface 7a.

The element body 7 includes a magnetic substrate 11; the magnetic resin layer 18; and an insulative layer 30.

The magnetic substrate 11 is a substantially flat substrate formed of a magnetic material such as ferrite (refer to FIG. 5). The magnetic substrate 11 is positioned on a side of the element body 7 which is opposite to the main surface 7a.

The magnetic resin layer 18 is formed on the magnetic substrate 11, and includes the coil 12 (to be described later) (refer to FIGS. 4 and 5) thereinside. The insulative layer 30 is formed on a surface of the magnetic resin layer 18 which is opposite to a magnetic substrate 11 side surface of the magnetic resin layer 18. The magnetic resin layer 18 is a mixture of magnetic powder and binder resin. The material of the magnetic powder is iron, carbonyl iron, silicon, chromium, nickel, boron, or the like. The material of the binder resin is epoxy resin or the like. The magnetic resin layer 18 may be formed of 90% or more magnetic powder in its entirety.

Each of a pair of the terminal electrodes 20A and 20B provided on the main surface 7a of the element body 7 has the shape of a film, and has a substantially rectangular shape in a top view. The terminal electrodes 20A and 20B have substantially the same area. The terminal electrodes 20A and 20B are formed of a conductive material such as Cu. The terminal electrodes 20A and 20B are plating electrodes which are formed via plating. The terminal electrodes 20A and 20B may have a single-layer structure or a multi-layer structure.

The insulative layer 30 is provided in such a way as to cover the entire region of the surface of the magnetic resin layer 18 which is opposite to the magnetic substrate 11 side surface. The insulative layer 30 include through holes (holes) 31a and 32a at positions corresponding to extracting conductors 19A and 19B (to be described later). The insulative layer 30 is formed of an insulative material, and is formed of insulative resin such as polyimide or epoxy.

As illustrated in FIGS. 4 and 5, the element body 7 of the coil component 10 includes the coil 12, a covering portion 17, and the extracting conductors 19A and 19B thereinside (specifically, inside of the magnetic resin layer 18).

The coil 12 is a planar coil that is wound into a rectangular shape in a top view. The coil 12 is formed of a metallic material such as Cu. The axial center of the coil 12 extends in a direction perpendicular to the main surface 7a. The coil 12 includes two coil conductor layers. The coil 12 includes a lower coil portion 13 and an upper coil portion 14 as the coil conductor layers, and connection portions 15 and 16. The lower coil portion 13 and the upper coil portion 14 are arranged in the direction (axial direction of the coil 12) perpendicular to the main surface 7a. The upper coil portion 14 is positioned closer to a main surface 7a side than the lower coil portion 13. The lower coil portion 13 and the upper coil portion 14 have the same winding direction. The connection portion 15 is interposed between the lower coil portion 13 and the upper coil portion 14. An innermost winding portion of the lower coil portion 13 is connected to an innermost winding portion of the upper coil portion 14 via the connection portion 15. The connection portion 16 extends from the lower coil portion 13 toward the main surface 7a side. The lower coil portion 13 is connected to the extracting conductor 19B via the connection portion 16.

The covering portion 17 includes an inorganic layer 17a and insulative resin layers (resin layers) 17b, 17c, 17d, and 17e. The inorganic layer 17a is formed of an inorganic material, for example, is formed of silicon nitride (SiN). The insulative resin layers 17b, 17c, 17d, and 17e are formed of insulative resin, for example, is formed of polyimide. The covering portion 17 integrally covers the lower coil portion 13 and the upper coil portion 14 of the coil 12 inside of the element body 7. The covering portion 17 individually covers the lower coil portion 13, the upper coil portion 14, and the connection portion 15. The covering portion 17 has a layered structure, and includes five layers 17a, 17b, 17c, 17d, and 17e in the embodiment (refer to FIG. 5).

The inorganic layer 17a is positioned on a lower side (magnetic substrate 11 side) of the lower coil portion 13. The inorganic layer 17a is formed in region in which the coil 12 is formed, and in an inside region of the coil 12 in a top view. Specifically, the inorganic layer 17a has the same shape as that of a region containing the region in which the coil 12 is formed and the inside region of the coil 12. Gaps between windings of and the periphery of the lower coil portion 13 are filled with the insulative resin layer 17b. The insulative resin layer 17b has an open region that corresponds to the inside region of the coil 12. The insulative resin layer 17c is interposed between the lower coil portion 13 and the upper coil portion 14, and has an open region that corresponds to the inside region of the coil 12. Gaps between windings of and the periphery of the upper coil portion 14 are filled with the insulative resin layer 17d. The insulative resin layer 17d has an open region that corresponds to the inside region of the coil 12. The insulative resin layer 17e is positioned on an upper side (main surface 7a side) of the upper coil portion 14, and has an open region that corresponds to the inside region of the coil 12.

The pair of extracting conductors 19A and 19B are formed of Cu, and extend from both end portions E1 and E2 of the coil 12 along the direction perpendicular to the main surface 7a. The extracting conductor 19A is connected to one end portion E1 of the coil 12, which is provided in an outermost winding portion of the upper coil portion 14. The extracting conductor 19A extends from the end portion E1 of the coil 12 to the main surface 7a of the element body 7 while passing through the magnetic resin layer 18. The extracting conductor 19A is exposed to the main surface 7a. The terminal electrode 20A is provided at a position corresponding to an exposed portion of the extracting conductor 19A. The end portion E1 of the coil 12 is electrically connected to the terminal electrode 20A via the extracting conductor 19A. The extracting conductor 19B is connected to the other end portion E2 of the coil 12, which is provided in an outermost winding portion of the lower coil portion 13. The extracting conductor 19B extends from the end portion E2 of the coil 12 to the main surface 7a of the element body 7 while passing through the magnetic resin layer 18. The extracting conductor 19B is exposed to the main surface 7a. The terminal electrode 20B is provided at a position corresponding to an exposed portion of the extracting conductor 19B. The end portion E2 of the coil 12 is electrically connected to the terminal electrode 20B via the extracting conductor 19B.

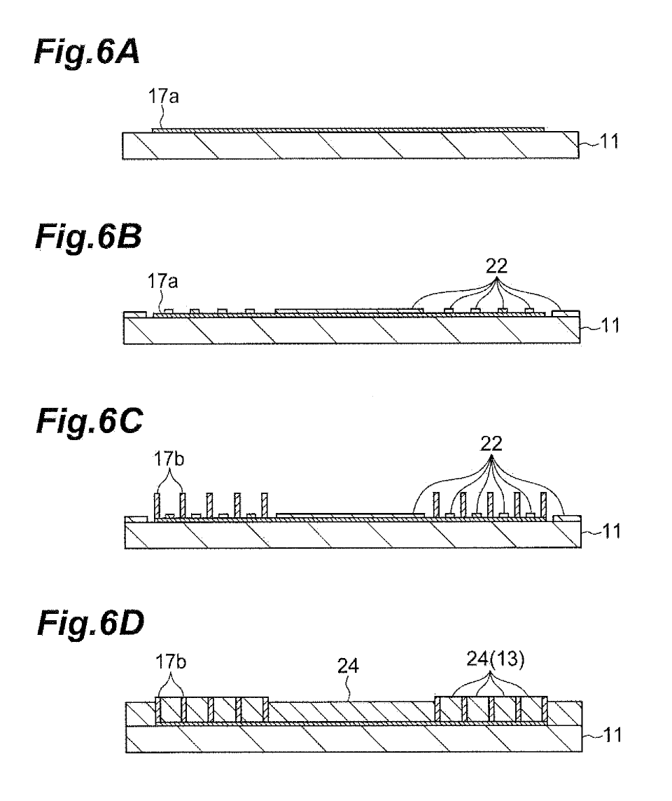

Hereinafter, a method of making the coil component 10 will be described with reference to FIGS. 6A to 6D, 7A to 7D, and 8A to 8D. FIGS. 6A to 6D, 7A to 7D, and 8A to 8D are views illustrating steps of making the coil component 10.

First, as illustrated in FIG. 6A, the inorganic layer 17a of the covering portion 17 is formed by depositing silicon nitride directly on the magnetic substrate 11. At this time, the inorganic layer 17a is patterned into the same shape as that of a region containing the region in which the coil 12 is formed and the inside region of the coil 12. Various well-known technologies can be used for the deposition of silicon nitride. For example, a sputtering method or a chemical vapor deposition (CVD) method can be used.

Subsequently, as illustrated in FIG. 6B, a seed portion 22 for forming the lower coil portion 13 is formed on the inorganic layer 17a via plating. It is possible to form the seed portions 22 using a predetermined mask via plating or a sputtering method. Subsequently, as illustrated in FIG. 6C, the insulative resin layer 17b of the covering portion 17 is formed. It is possible to obtain the insulative resin layer 17b by coating the entire surface of the magnetic substrate 11 with polyimide and then removing polyimide at a position corresponding to the seed portion 22. That is, the insulative resin layer 17b covers the entire surface of the magnetic substrate 11 in a state where the seed portion 22 is exposed. The insulative resin layer 17b is a wall-like portion is erected on the magnetic substrate 11, and divides a region in which the lower coil portion 13 is formed. Subsequently, as illustrated in FIG. 6D, a plating layer 24 is formed in gaps of the insulative resin layer 17b using the seed portion 22. At this time, plating develops a layer with which regions divided by the gaps of the insulative resin layer 17b is filled, and the developed plating layer serves as the lower coil portion 13. In other words, the lower coil portion 13 with the insulative resin layer 17b interposed between the windings of the lower coil portion 13 is obtained. A lower surface of the lower coil portion 13 is in direct contact with the inorganic layer 17a.

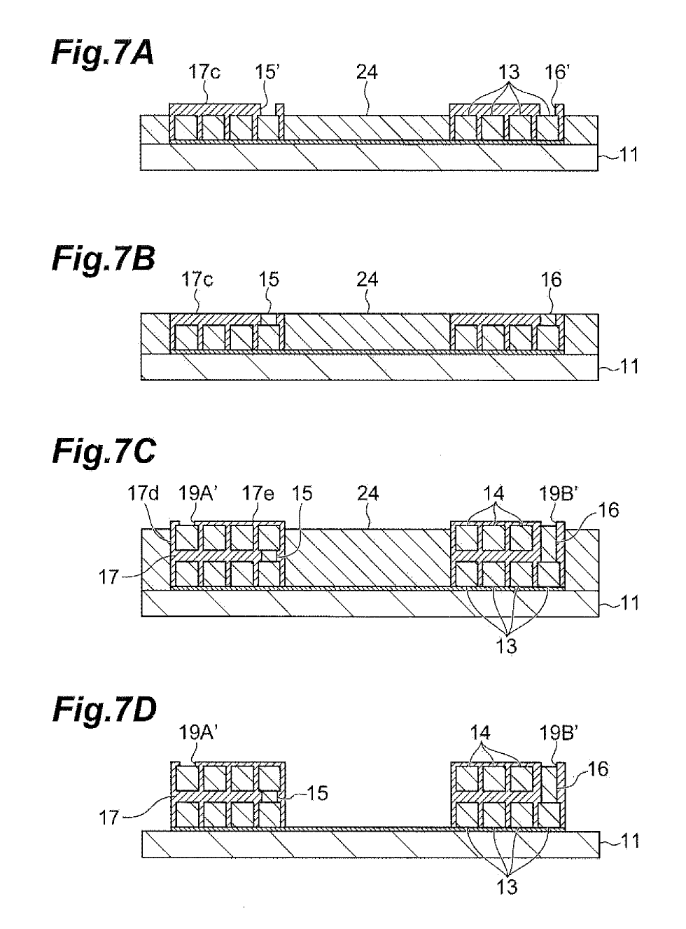

Subsequently, as illustrated in FIG. 7A, the insulative resin layer 17c of the covering portion 17 is formed by pattern-coating an upper side of the lower coil portion 13 with a polyimide paste. At this time, opening portions 15′ and 16′ for forming the connection portions 15 and 16 are formed in the insulative resin layer 17c. Subsequently, as illustrated in FIG. 7B, the connection portions 15 and 16 are respectively formed in the opening portions 15′ and 16′ of the insulative resin layer 17c via plating.

Subsequently, as illustrated in FIG. 7C, the upper coil portion 14 and the insulative resin layers 17d and 17e of the covering portion 17 are formed on the insulative resin layer 17c according to the same as the aforementioned step. Specifically, according to the same as the sequence illustrated in FIGS. 6B to 6D, a seed portion for forming the upper coil portion 14 via plating is formed. The insulative resin layer 17d made of polyimide, which divides a region in which the upper coil portion 14 is formed, is formed. The upper coil portion 14 is formed in gaps of the insulative resin layer 17d via plating.

The insulative resin layer 17e of the covering portion 17 is formed by pattern-coating an upper side of the upper coil portion 14 with a polyimide paste. At this time, opening portions 19A′ and 19B′ for forming the extracting conductor 19A and 19B are formed in the insulative resin layer 17e. As described above, the covering portion 17 has a layered structure including multiple layers 17a to 17e. The lower coil portion 13 and the upper coil portion 14 are surrounded by the layers 17a to 17e.

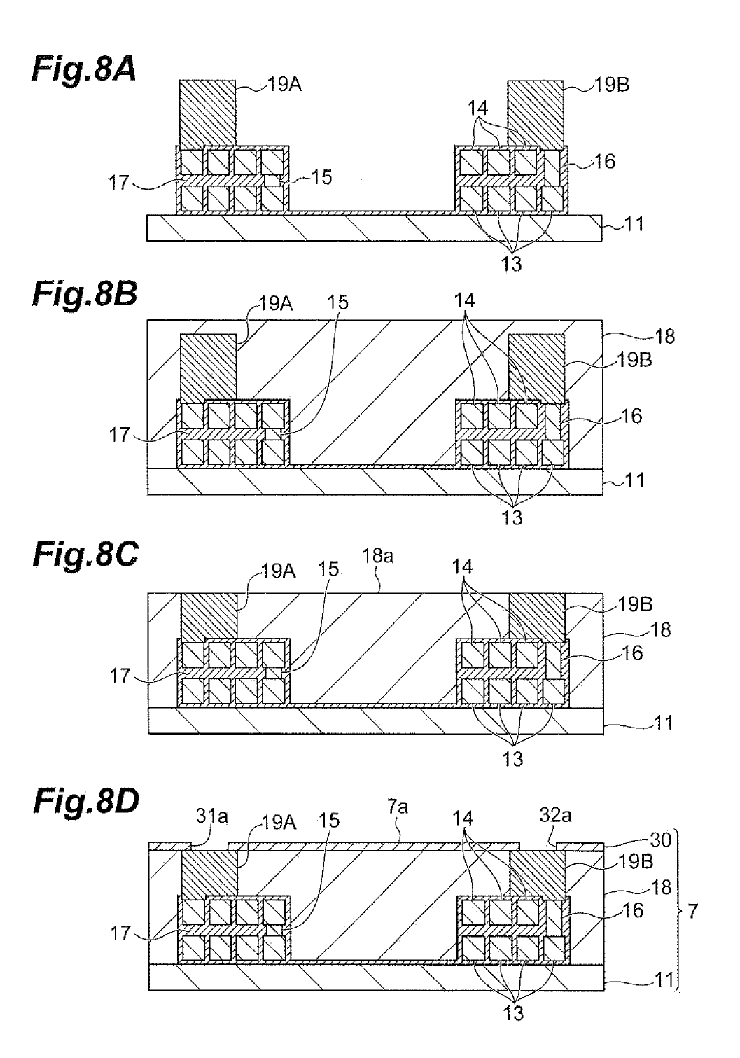

Subsequently, as illustrated in FIG. 7D, portions (portions that correspond to inside portions and outer peripheral portions of the lower coil portion 13 and the upper coil portion 14) of the plating layer 24, which do not form the lower coil portion 13 and the upper coil portion 14, are removed via an etching process. In other words, portions of the plating layer 24, which are not covered with the covering portion 17 in FIG. 7C, are removed. Subsequently, as illustrated in FIG. 8A, the extracting conductor 19A is formed at a position corresponding to the opening portion 19A′ of the insulative resin layer 17e, and the extracting conductor 19B is formed at a position corresponding to the opening portion 19B′. Specifically, seed portions for the extracting conductors 19A and 19B are formed on the opening portions 19A′ and 19B′ using a predetermined mask via plating or sputtering, and the extracting conductors 19A and 19B are formed using the seed portions via plating.

Subsequently, as illustrated in FIG. 8B, the magnetic resin layer 18 is formed by coating the entire surface of the magnetic substrate 11 with magnetic resin and hardening the magnetic resin by a predetermined method. As a result, the peripheries of the covering portion 17 and the extracting conductors 19A and 19B are covered with the magnetic resin layer 18. At this time, the inside portion of the coil 12 is filled with the magnetic resin layer 18. Subsequently, as illustrated in FIG. 8C, grinding is performed such that the extracting conductors 19A and 19B are exposed from the magnetic resin layer 18.

Subsequently, as illustrated in FIG. 8D, the insulative layer 30 is formed by coating an upper surface 18a of the magnetic resin layer 18 with an insulative material such as an insulative resin paste before forming the terminal electrodes 20A and 20B via plating. The insulative layer 30 is formed such that the entirety of the upper surface 18a of the magnetic resin layer 18 is covered with the insulative layer 30, the through holes 31a and 32a are formed in the insulative layer 30 at the positions corresponding to the pair of extracting conductors 19A and 19B, and the pair of extracting conductors 19A and 19B are exposed from the insulative layer 30. Specifically, the entire region of the main surface 7a is coated with an insulative material, and thereafter, portions of the insulative layer 30 at locations corresponding to the extracting conductors 19A and 19B are removed.

According to the aforementioned steps, the element body 7, in which the extracting conductors 19A and 19B are exposed from the main surface 7a of the element body 7, is obtained.

Finally, the coil component 10 is finished by forming the terminal electrodes 20A and 20B on the main surface 7a of the element body 7. In order to form the terminal electrodes 20A and 20B, first, seed portions (not illustrated) are formed in regions, which correspond to the terminal electrodes 20A and 20B, using a predetermined mask via plating or sputtering. Seed portions are also formed on the extracting conductors 19A and 19B which are exposed from the through holes 31a and 32a of the insulative layer 30. Subsequently, the terminal electrodes 20A and 20B are formed using the seed portions via electroplating or electroless plating. At this time, plating develops layers with which the through holes 31a and 32a of the insulative layer 30 are filled, and the developed plating layers form portions of the extracting conductors 19A and 19B.

As described above, the coil component 10 includes the coil 12; the inorganic layer 17a that is provided on a lower surface (that is, magnetic substrate 11 side surface) of the coil 12, and is in direct contact with the coil 12; and the insulative resin layers 17b, 17c, 17d, and 17e with which an upper surface of the coil 12 is covered and gaps between windings are filled.

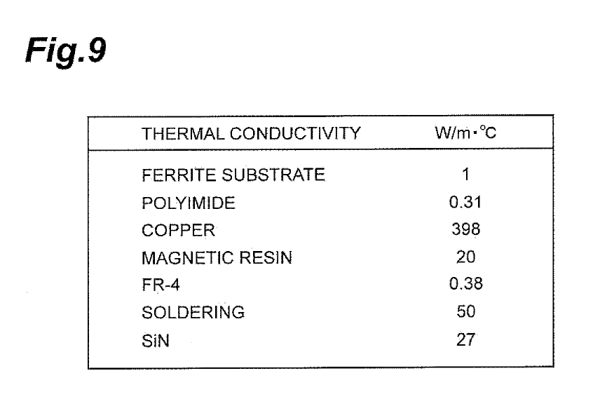

The inorganic layer 17a formed of silicon nitride has a thermal conductivity higher than that of the insulative resin layers 17b, 17c, 17d, and 17e formed of polyimide. The table of FIG. 9 illustrates thermal conductivities of various materials of the coil component 10. As illustrated in the table of FIG. 9, the thermal conductivity (27 W/m·° C.) of silicon nitride which is the material of the inorganic layer 17a is much higher than that (0.31 W/m·° C.) of polyimide which is the material of the insulative resin layers 17b, 17c, 17d, and 17e. That is, the inorganic layer 17a more easily transfer heat than the insulative resin layers 17b, 17c, 17d, and 17e.

If a voltage is input to the coil component 10, the coil 12 generates heat due to current flowing through the coil 12, and an event in which the coil 12 and the periphery of the coil 12 are overheated may occur. Particularly, if a large current flows through the coil 12, such overheating is likely to occur. In this case, heat inside the coil component 10 is dissipated toward the outside to some extent.

As illustrated in the table of FIG. 9, since copper has a very high thermal conductivity (398 W/m·° C.), it is considered that heat inside the coil component 10 is transferred to the outside mainly along the coil 12 formed of copper. It is considered that particularly, since polyimide having a low thermal conductivity, with which the periphery of the coil 12 is covered, obstructs dissipation of heat to the outside of the coil 12, heat transfer along the coil 12 in the coil component 10 is dominant. In contrast, since the coil 12 is wound, a heat transfer route to the outside of the coil component 10 along the coil 12 is relative long, heat dissipation efficiency is low, and a heat dissipation speed is also low.

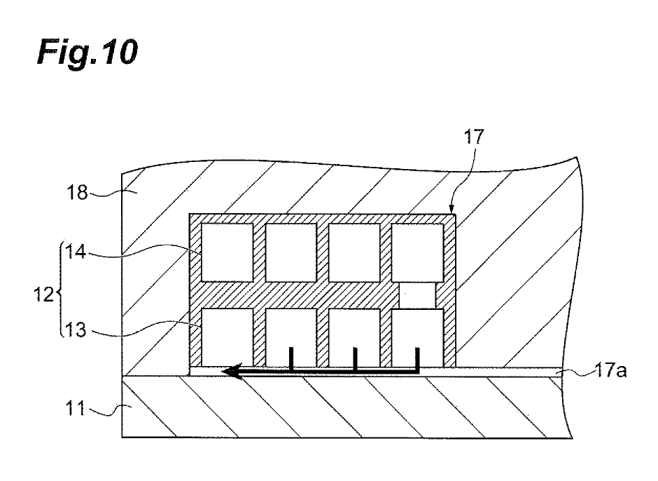

In the coil component 10, heat transfer from a high temperature side (inside of the coil in the embodiment) of the coil 12 to a low temperature side (outside of the coil in the embodiment) is supplemented via the inorganic layer 17a which is formed of silicon nitride having a relative low thermal conductivity and is in direct contact with the lower surface of the coil 12. That is, as illustrated by the arrow in FIG. 10, heat is transferred to winding portions of the coil 12 adjacent to the inorganic layer 17a in a sectional view via the inorganic layer 17a, and thus, a heat transfer route is cut short, and is shorter than the heat transfer route along the winding shape of the coil 12. As a result, the heat dissipation efficiency and the heat dissipation speed of the coil component 10 improve, and high dissipation of the coil component 10 is realized.

That is, in the coil component 10, the inorganic layer 17a provided on a lower surface side of the coil 12 has a thermal conductivity higher than that of the resin layers 17b, 17c, 17d, and 17e with which the upper surface of the coil 12 is covered and the gaps between the windings are filled. As a result, heat transfer from the inside of the coil 12 to the outside is supplemented via the inorganic layer 17a. That is, heat transfer of the coil 12 via the inorganic layer 17a is facilitated, and the heat dissipation of the coil component 10 improves.

The shape of the inorganic layer 17a is not limited to the same as the shape of the region containing the region in which the coil 12 is fat wed and the inside region of the coil 12, and the inorganic layer 17a may have various shapes.

The inventors have confirmed the following relationship between the shape of the inorganic layer and the heat dissipation of the coil component via simulation.

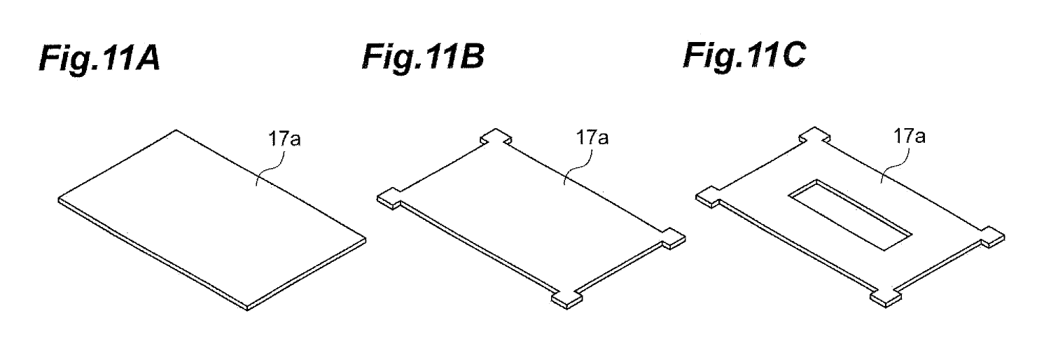

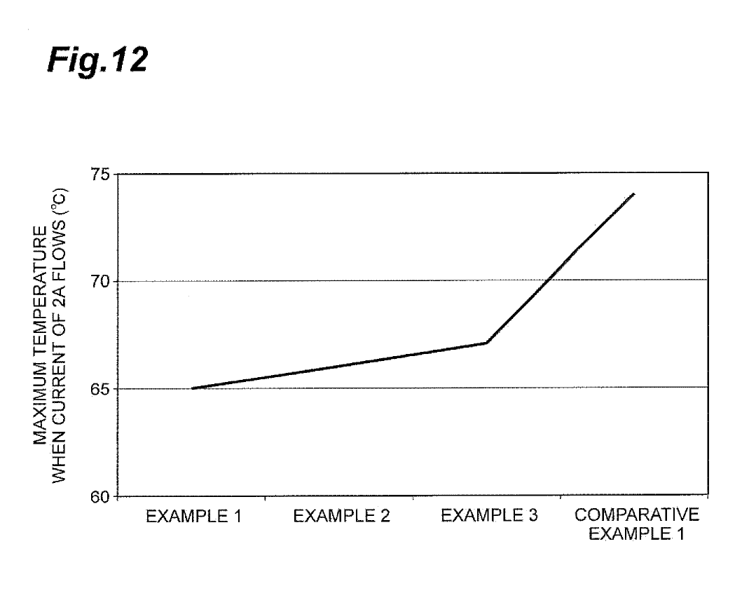

First, as illustrated in FIGS. 11A to 11C, the inorganic layers 17a of three shapes were prepared. The inorganic layer 17a of Example 1 illustrated in FIG. 11A is formed in the entire region of the main surface of the magnetic substrate 11. The inorganic layer 17a of Example 2 illustrated in FIG. 11B is formed in a region containing the region in which the coil 12 is formed and the inside region of the coil 12 (that is, equivalent to the inorganic layer of the aforementioned embodiment). The inorganic layer 17a of Example 3 illustrated in FIG. 11C is formed only in the region in which the coil 12 is formed. Only a difference between the inorganic layers 17a is a shape, and other conditions thereof such as materials are the same. The three coil components 10 including the inorganic layers 17a (Examples 1 to 3) were prepared. For comparative purposes, a coil component including a polyimide layer (Comparative Example 1) instead of the inorganic layer 17a was prepared. Maximum temperatures when a current of 2A flows through the coil components were obtained via simulation. Simulation software (Design Space) produced by ANSYS Co. was used in the simulation. A simulation result is illustrated in the graph of FIG. 12. In the graph of FIG. 12, the horizontal axis represents each example and the comparative example, and the vertical axis represents maximum temperature (° C.) when a current of 2A flows through the coil components.

As being apparent from the graph of FIG. 12, a maximum temperature in any one of Examples 1 to 3 is lower than that of Comparative Example 1. It has been confirmed that the inorganic layer 17a is effective in lowering the maximum temperature of the coil component 10, and is effective in improving heat dissipation. It has been ascertained that the maximum temperature particularly in Example 1 is lower than those of Examples 2 and 3.

The configuration of the coil component 10 is not limited to the aforementioned configuration, and the coil component 10 may have various configurations.

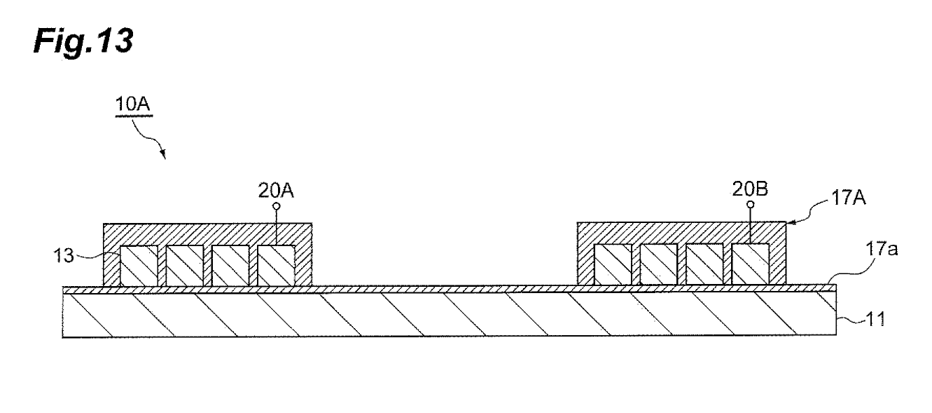

For example, the configuration of a coil component 10A illustrated in FIG. 13 may be adopted. The coil component 10A includes the magnetic substrate 11; a coil (planar coil) 13 equivalent to the lower coil portion 13; and a covering portion 17A that covers the coil 13. Terminal electrodes 20A and 20B are respectively connected to end portions of the coil 13 via extracting conductors (not illustrated). The covering portion 17A of the coil component 10A includes the same layers as the inorganic layer 17a and the insulative resin layers 17b and 17c of the aforementioned embodiment.

Similar to the coil component 10, in the coil component 10A, the inorganic layer 17a of the covering portion 17A which is provided on a lower surface side of the coil 13 has a thermal conductivity higher than that of other layers of the covering portion 17A with which an upper surface of the coil 13 is covered and gaps between windings are filled. As a result, heat transfer from the inside of the coil 13 to the outside is supplemented via the inorganic layer 17a. That is, heat transfer of the coil 13 via the inorganic layer 17a is facilitated, and heat dissipation of the coil component 10A improves.

This disclosure is not limited to the aforementioned embodiment, and the aforementioned embodiment may be modified or may be adopted in other manners insofar as the modification or adaptation does not change the concept disclosed in the claims.

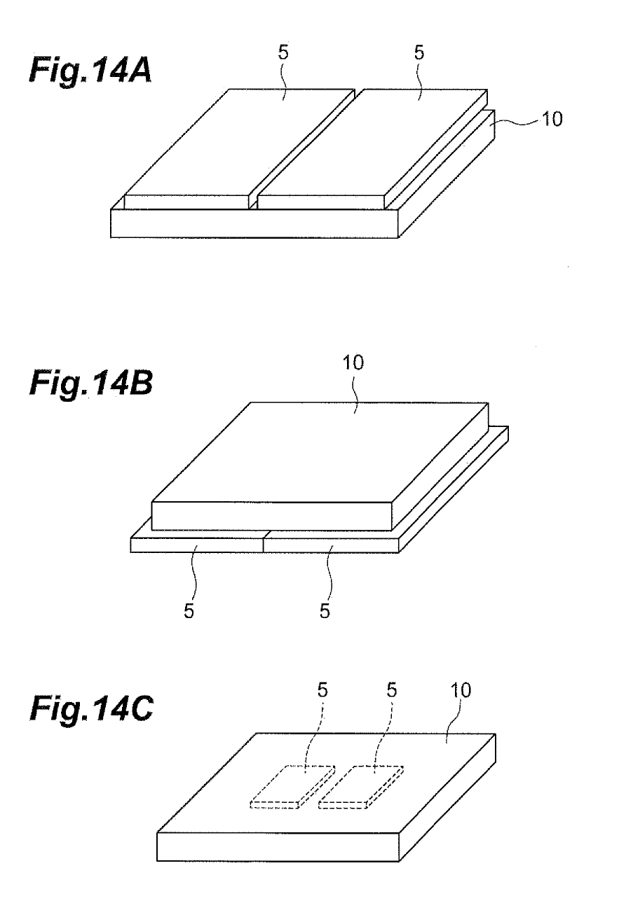

For example, the configuration of the coil component is not limited to the configurations of the coil components 10 and 10A, and configurations illustrated in FIGS. 14A to 14C may be adopted. In the configuration illustrated in FIG. 14A, the coil component 10 includes two capacitors 5 on the outside thereof; and the capacitors 5 are mounted on the coil component 10. In the configuration illustrated in FIG. 14B, the coil component 10 includes two capacitors 5 on the outside thereof, and the coil component 10 is mounted across the capacitors 5. FIG. 14C illustrates the coil component 10 including two capacitors 5 on the inside thereof.

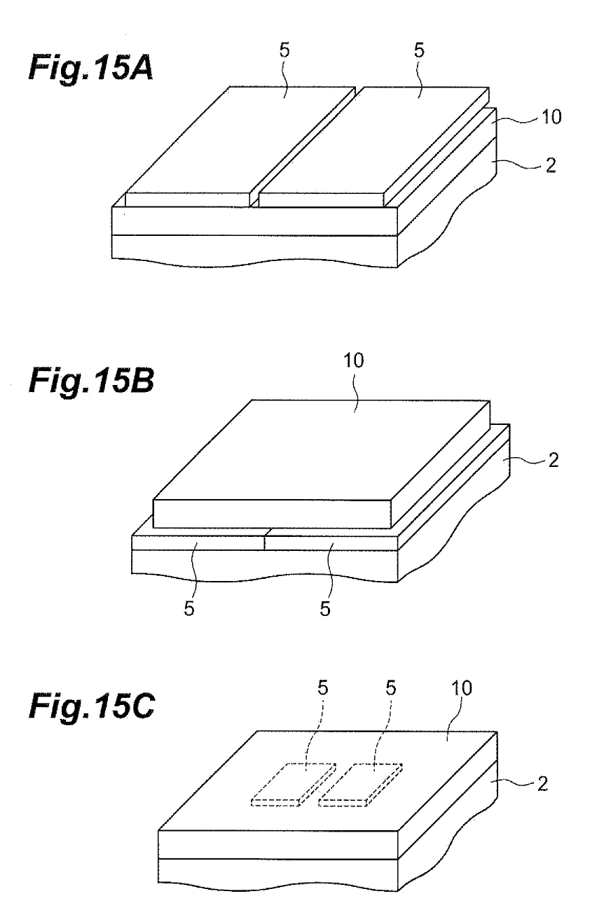

The configuration of the power supply circuit unit is not limited to the configuration of the power supply circuit unit 1, and configurations illustrated in FIGS. 15A to 15C may be adopted. FIG. 15A illustrates a portion of a power supply circuit unit having a configuration in which the coil component 10 is mounted on the circuit substrate 2, and two capacitors 5 are mounted on the coil component 10. FIG. 15B illustrates a portion of a power supply circuit unit having a configuration in which two capacitors 5 are mounted on the circuit substrate 2, and the coil component 10 is mounted across the two capacitors 5. FIG. 15C illustrates a portion of a power supply circuit unit having a configuration in which the coil component 10 including two capacitors 5 on the inside thereof is mounted on the circuit substrate 2.

The material of the inorganic layer is not limited to SiN insofar as the material is an inorganic material. Alternatively, the material may be alumina or the like. The shape of winding of the coil is not limited to a rectangular shape in a top view. Alternatively, the coil may be wound into a perfect circular shape or an elliptical shape. The number of windings of the coil can be suitably increased or decreased. The number of coil conductor layers of the coil is not limited two, and alternatively, may be one or three or more. The element body of the aforementioned embodiment includes an uppermost insulative layer, and alternatively, the insulative layer may be suitably omitted.

What is claimed is:

1. A coil component comprising:
a planar coil;
an inorganic layer provided on a side of one surface of the planar coil and in direct contact with the planar coil; and
a resin layer covering the other surface of the planar coil, the resin layer filling gaps between windings of the planar coil.

2. The coil component according to claim 1,
wherein the shape of the inorganic layer is the same as that of a forming region of the planar coil.

3. The coil component according to claim 1,
wherein the shape of the inorganic layer is the same as that of a region including a forming region of the planar coil and an inside region of the planar coil.

4. The coil component according to claim 1, further comprising:
an element body having a magnetic resin layer covering the planar coil, the inorganic layer, and the resin layer, the element body having a mounting surface;
a pair of terminal electrodes provided on the mounting surface of the element body; and
a pair of extracting conductors extending from end portions of the planar coil to the pair of terminal electrodes.

5. The coil component according to claim 1, further comprising:
at least one of capacitor structures inside or outside of the coil component.

6. A power supply circuit unit comprising:
the coil component according to claim 1.

7. The power supply circuit unit according to claim 6, further comprising:
at least one capacitor.
